(19) United States
(12) Patent Application Publication
(10) Pub. No.: US 2026/0238144 A1
(43) Pub. Date: Aug. 13, 2026

(54) MOTOR DRIVING DEVICE, MOTOR DRIVING METHOD, AND REFRIGERATION CYCLE APPARATUS

(71) Applicant: Mitsubishi Electric Corporation, Tokyo (JP)

(72) Inventors: Kosuke FUJITA, Tokyo (JP); Junki ISHIZAKI, Tokyo (JP)

(21) Appl. No.: 19/154,941

(22) PCT Filed: Apr. 13, 2023
(86) PCT No.: PCT/JP2023/015009

§ 371 Date: Aug. 8, 2025

(51) Int. Cl. H02P 5/50; F25B 49/02

(52) U.S. Cl. CPC H02P 5/50; F25B 49/022; F25B 2700/151

(57) ABSTRACT

A motor driving device reduces occurrence of an out-of-step condition.

The motor driving device includes: voltage conversion circuitry that applies to first and second motors, an AC voltage obtained by converting an AC voltage output from an AC power source based on a voltage command value; and a controller that determines command value based on a parameter of the second motor, when a second current value of current flowing in the second motor is greater than a first current value of current flowing in the first motor and a current difference value that is an absolute value of a difference between the first and second current values is greater than a predetermined threshold, and determines the voltage command value based on a parameter of the first motor, when the first current value is greater than the second current value and the current difference value is greater than the threshold.

### TECHNICAL FIELD

### The present disclosure relates to a motor driving device, a motor driving method, and a refrigeration cycle apparatus.

### BACKGROUND ART

In existing techniques, it is known that multiple motors can be driven by a single inverter. For example, a motor driving device disclosed in Patent Literature 1 drives a multiphase first motor and a second motor having the same number of phases as the first motor, with each of phases of both the motors connected to an associated common output line. Pulse width modulation (PWM) control is performed based on a rotation speed of the first motor that is detected by a rotation sensor.

### CITATION LIST

### Patent Literature

Patent Literature 1: Japanese Unexamined Patent Application Publication No. 2004-297874

### SUMMARY OF INVENTION

### Technical Problem

However, the motor driving device disclosed in Patent Literature 1 detects only the rotation speed of the first motor and performs the PWM control over the first motor and the second motor, and does not detect the rotation speed of the second motor.

Thus, due to the installation environment of the motor or the characteristics of the motor itself, the load on the second motor may become larger than that on the first motor. In such a case, the rotational speed of the second motor may fail to reach a target rotation speed. Furthermore, if the rotational speed of the second motor deviates from a control range, a problem arises in which an out-of-step condition occurs in the control.

The present disclosure is applied to solve the above problem, and aims at reducing occurrence of an out-of-step condition in the control.

### Solution to Problem

A motor driving device according to an embodiment of the present disclosure includes voltage conversion circuitry configured to apply to a first motor and a second motor, a converted AC voltage obtained by converting an AC voltage output from an AC power source based on a voltage command value, and a controller configured to determine the voltage command value based on a parameter of the second motor, when a second current value that is the value of a current flowing in the second motor is greater than a first current value that is the value of a current flowing in the first motor and a current difference value that is an absolute value of a difference between the first current value and the second current value is greater than a predetermined threshold, and determine the voltage command value based on a parameter of the first motor, when the first current value is greater than the second current value and the current difference value is greater than the threshold, determine the voltage command value based on a parameter of the first motor.

In addition, a motor driving method according to another embodiment of the present disclosure includes: a first step of obtaining a first current value that is applied to a first motor and a second current value that is applied to a second motor; a second step of calculating a current difference value that is an absolute value of a difference between the first current value and the second current value that are obtained in the first step; a third step of using the second motor as a main motor when the second current value is greater than the first current value and the current difference value is greater than a predetermined threshold, and using the first motor as the main motor when the first current value is greater than the second current value and the current difference value is greater than the threshold; and a fourth step of applying to the first motor and the second motor, a converted AC voltage obtained by converting an AC voltage output from an AC power source based on a voltage command value determined based on a parameter of the main motor determined in the third step.

Furthermore, a refrigeration cycle apparatus according to still another embodiment of the present disclosure includes: a compressor; an outdoor heat exchanger including a first outdoor heat exchanger that is provided with a first motor and a second outdoor heat exchanger that is provided with a second motor and connected along with the first outdoor heat exchanger in parallel with a refrigerant circuit; a pressure reducing device; an indoor heat exchanger; refrigerant pipes that connect the compressor, the outdoor heat exchanger, the pressure reducing device, and the indoor heat exchanger so that refrigerant circulates through the compressor, the outdoor heat exchanger, the pressure reducing device, and the indoor heat exchanger; and a motor driving device including voltage conversion circuitry configured to apply to the first motor and the second motor, a converted AC voltage obtained by converting an AC voltage output from an AC power source based on a voltage command value, and a controller configured to determine the voltage command value based on a parameter of the second motor, when a second current value of a current flowing in the second motor is greater than a first current value of a current flowing in the first motor and a current difference value that is an absolute value of a difference between the first current value and the second current value is greater than a predetermined threshold, and to determine the voltage command value based on a parameter of the first motor, when the first current value is greater than the second current value and the current difference value is greater than the threshold.

### Advantageous Effects of Invention

The motor driving device, the motor driving method, and the refrigeration cycle apparatus according to the embodiments of the present disclosure can reduce occurrence of an out-of-step condition.

### BRIEF DESCRIPTION OF DRAWINGS

FIG. 1 is a refrigerant circuit diagram illustrating an overview of a refrigeration cycle apparatus according to Embodiment 1.

FIG. 2 is a schematic view illustrating a configuration of an outdoor heat exchanger according to Embodiment 1.

FIG. 3 is a schematic view illustrating a configuration of a motor driving device according to Embodiment 1.

FIG. 4 is a block diagram illustrating a hardware configuration of a controller included in the motor driving device according to Embodiment 1.

FIG. 5 is a block diagram illustrating a functional configuration of the controller included in the motor driving device according to Embodiment 1.

FIG. 6 is a flowchart illustrating a main-motor switching determination processing by the controller included in the motor driving device according to Embodiment 1.

FIG. 7 is a schematic view illustrating a configuration of a motor driving device according to Embodiment 2.

FIG. 8 is a block diagram illustrating a hardware configuration of a controller included in the motor driving device according to Embodiment 2.

FIG. 9 is a block diagram illustrating a functional configuration of the controller included in the motor driving device according to Embodiment 2.

FIG. 10 is a flowchart illustrating a main-motor switching determination processing by the controller included in the motor driving device according to Embodiment 2.

FIG. 11 is a flowchart illustrating a mode switching determination processing by the controller included in the motor driving device according to Embodiment 2.

FIG. 12 is a flowchart illustrating processing in an emergency operation mode in a mode switching determination processing by the controller included in the motor driving device according to Embodiment 2.

FIG. 13 is a schematic view illustrating a configuration of a motor driving device according to Embodiment 3.

FIG. 14 is a block diagram illustrating a hardware configuration of a controller included in the motor driving device according to Embodiment 3.

FIG. 15 is a block diagram illustrating a functional configuration of the controller included in the motor driving device according to Embodiment 3.

FIG. 16 is a flowchart illustrating processing of an emergency operation mode in a mode switching determination processing by the controller included in the motor driving device according to Embodiment 3.

### DESCRIPTION OF EMBODIMENTS

A motor driving device, a motor driving method, and a refrigeration cycle apparatus according to Embodiment 1 of the present disclosure will be described with reference to the figures. It should be noted that the present disclosure is not limited to the following embodiments only, and modifications or omissions can be made without departing from the gist of the present disclosure. In addition, in each of the figures, components that are the same as those in a previous figure or previous figures are denoted by the same reference signs, and with respect to those components, after a component is described once, its description will not be repeated.

### Embodiment 1

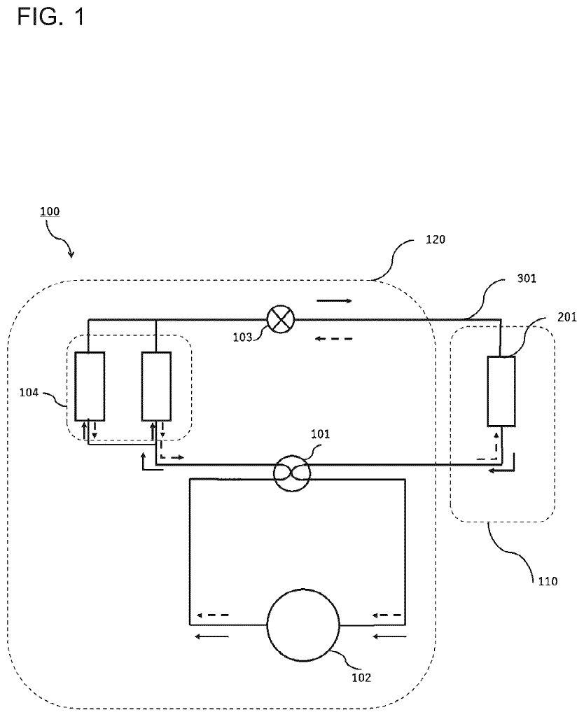

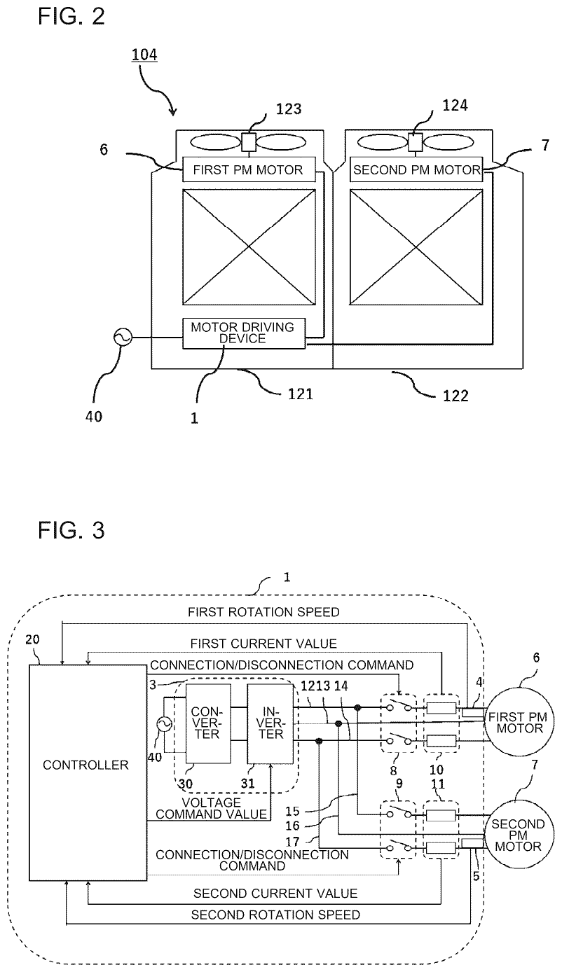

FIG. 1 is a refrigerant circuit diagram illustrating an overview of a refrigeration cycle apparatus 100 according to Embodiment 1. FIG. 2 is a schematic view illustrating a configuration of an outdoor heat exchanger 104 according to Embodiment 1. The configuration of the refrigeration cycle apparatus 100 will be described with reference to FIGS. 1 and 2.

As illustrated in FIG. 1, the refrigeration cycle apparatus 100 includes an indoor unit 110 and an outdoor unit 120. In FIG. 1, flows of refrigerant in a heating operation in the refrigeration cycle apparatus 100 are indicated by dashed arrows and flows of refrigerant in a cooling operation are indicated by solid arrows.

The indoor unit 110 is fixedly installed in a room. The indoor unit 110 includes an indoor heat exchanger 201 configured to operate as an evaporator in the cooling operation and operate as a condenser in a heating operation. The indoor heat exchanger 201 includes an indoor fan (not illustrated) configured to send an indoor air.

As illustrated in FIG. 1, the outdoor unit 120 is fixedly installed outdoors. In the outdoor unit 120, a four-way valve 101 configured to switch a refrigerant circuit between that for the heating operation and that for the cooling operation, a compressor 102 configured to compress the refrigerant, a pressure reducing device 103 configured to reduce the pressure of the refrigerant, and an outdoor heat exchanger 104 configured to operate as a condenser in the cooling operation and operate as an evaporator in the heating operation are connected by pipes 301 to communicate with each other. Specifically, the pressure reducing device 103 is an expansion valve.

As illustrated in FIG. 2, the outdoor heat exchanger 104 according to Embodiment 1 includes a first outdoor heat exchanger 121 and a second outdoor heat exchanger 122. The first outdoor heat exchanger 121 and the second outdoor heat exchanger 122 are top-flow type heat exchangers. The first outdoor heat exchanger 121 and the second outdoor heat exchanger 122 are connected in parallel with each other in the refrigerant circuit.

The first outdoor heat exchanger 121 includes a motor driving device 1, a first permanent magnet (PM) motor 6, and a first fan 123.

The motor driving device 1 is configured to receive a voltage output from an alternating current (AC) power source 40 and output the voltage to the first PM motor 6 and a second PM motor 7 to drive the first PM motor 6 and the second PM motor 7. In addition, the motor driving device 1 is configured to perform a vector control of the first PM motor 6 and the second PM motor 7 to determine a voltage command value of a voltage to be applied to each of the first PM motor 6 and the second PM motor 7.

The vector control is a control method in which control is performed by dividing a current of each phase that is applied to a motor into a magnetic flux current component (d-axis) and a torque current component (q-axis). The vector control method may be, for example, a sensorless vector control method not using a feedback signal from a sensor, or a vector control method with encoder feedback in which a feedback by an encoder is obtained. The control method in Embodiment 1 is the vector control method with encoder feedback.

Because the vector control with encoder feedback can perform control in consideration of not only the magnitude of a voltage and the frequency but also the flow direction of current, and thus has a characteristic in which disturbance in torque does not occur even when a load or a rotation speed is suddenly changed.

The first PM motor 6 is configured to drive the first fan 123. A PM motor is a motor in which a permanent magnet is embedded in a rotor, and is, for example, an SPM motor or an IPM motor. The first fan 123 is configured to send outdoor air.

The second outdoor heat exchanger 122 includes the second PM motor 7 and a second fan 124. The second PM motor 7 is configured to drive the second fan 124. The second fan 124 is configured to send outdoor air.

FIG. 3 is a schematic view illustrating a configuration of the motor driving device 1 according to Embodiment 1. The configuration of the motor driving device 1 will be described with reference to FIG. 3.

The motor driving device 1 includes voltage conversion circuitry 3, a first rotation detector 4, a second rotation detector 5, a first disconnection contactor 8, a second disconnection contactor 9, a first current detector 10, a second current detector 11, and a controller 20.

The voltage conversion circuitry 3 is configured to convert an AC voltage output from an AC power source based on a voltage command value determined by the controller 20 and apply the converted AC voltage to the first PM motor 6 and the second PM motor 7. The voltage conversion module includes a converter 30 and an inverter 31.

As illustrated in FIG. 3, the converter 30 is connected to an AC power source 40 and the inverter 31. The converter 30 is configured to convert an AC voltage supplied from the AC power source 40 into a direct current (DC) voltage. The inverter 31 is connected to the converter 30, the first PM motor 6, and the second PM motor 7 by power lines. In addition, the inverter 31 is connected parallel to the first PM motor and the second PM motor. The inverter 31 is configured to convert the DC voltage supplied from the converter into a three-phase AC voltage based on the voltage command value and output the converted voltage to the first PM motor 6 and the second PM motor 7. More specifically, the inverter 31 is connected to the first PM motor by a first U-phase power line 12, a first V-phase power line 13, and a first W-phase power line 14. In addition, the inverter 31 is connected to the second PM motor 7 by a second U-phase power line 15 that branches off from the first U-phase power line 12, a second V-phase power line 16 that branches off from the first V-phase power line 13, and a second W-phase power line 17 that branches off from the first W-phase power line 14.

The first rotation detector 4 is configured to detect a first rotation speed that is the rotation speed of the first PM motor. In addition, the first rotation detector 4 is configured to transmit a signal including the detected first rotation speed to the controller 20. The first rotation detector 4 is, for example, a rotation angle sensor.

The second rotation detector 5 is configured to detect a second rotation speed that is the rotation speed of the second PM motor. In addition, the second rotation detector 5 is configured to transmit a signal including the detected second rotation speed to the controller 20. The second rotation detector is, for example, a rotation angle sensor.

The first disconnection contactor 8 is inserted in series into two of three first power lines located between the inverter 31 and the first PM motor 6. In Embodiment 1, the first disconnection contactor 8 is inserted into the first U-phase power line 12 and the first W-phase power line. The first disconnection contactor 8 is configured to perform switching between connection and disconnection of the power lines in response to a command from the controller 20 to control energization to the first PM motor.

The second disconnection contactor 9 is inserted in series into two of the three second power lines between the inverter 31 and the second PM motor 7. In Embodiment 1, the second disconnection contactor 9 is inserted into the second U-phase power line 15 and the second W-phase power line 17. The second disconnection contactor 9 is configured to perform switching between connection and disconnection of the power lines in response to a command from the controller 20 to control energization to the second PM motor.

With the first disconnection contactor 8 and the second disconnection contactor 9, the outdoor heat exchanger according to Embodiment 1 can operate according to the air-conditioning capacity. To be more specific, when the air-conditioning capacity of the refrigeration cycle apparatus 100 is small, it is possible to drive only one of the first PM motor 6 and the second PM motor 7 by connecting only the power line for the one of the first PM motor 6 and the second PM motor 7 thereto, and disconnecting the power line for the other therefrom. In addition, when the air-conditioning capacity of the refrigeration cycle apparatus 100 is large, it is possible to drive both the first PM motor 6 and the second PM motor 7 by connecting the power lines for first PM motor 6 and the second PM motor 7 thereto.

The first current detector 10 is inserted in series into two of the three first power lines between the inverter 31 and the first PM motor 6. In Embodiment 1, the first current detector 10 is inserted into the first U-phase power line 12 and the first W-phase power line 14. That is, the first current detector 10 is configured to detect an instantaneous value I1u of current in the first U-phase power line and an instantaneous value I1w of current in the first W-phase power line. In addition, the first current detector 10 is configured to transmit a signal including the detected instantaneous value I1u of the current in the first U-phase power line and the detected instantaneous value I1w of the current in the first W-phase power line to the controller 20. The first current detector 10 is, for example, a current sensor.

The second current detector 11 is inserted in series into two of the three first power lines between the inverter 31 and the second PM motor 7. In Embodiment 1, the second current detector 11 is inserted into the second U-phase power line 15 and the second W-phase power line 17. That is, the second current detector 11 is configured to detect an instantaneous value I2u of current in the second U-phase power line and an instantaneous value I2w of current in the second W-phase power line 17.

In addition, the second current detector 11 is configured to transmit a signal including the detected instantaneous value I2u of the current in the second U-phase power line and the detected instantaneous value I2w of the current in the second W-phase power line to the controller 20. The second current detector 11 is, for example, a current sensor.

The first current detector 10 and the second current detector 11 are each configured to obtain an instantaneous value of the current at predetermined time intervals.

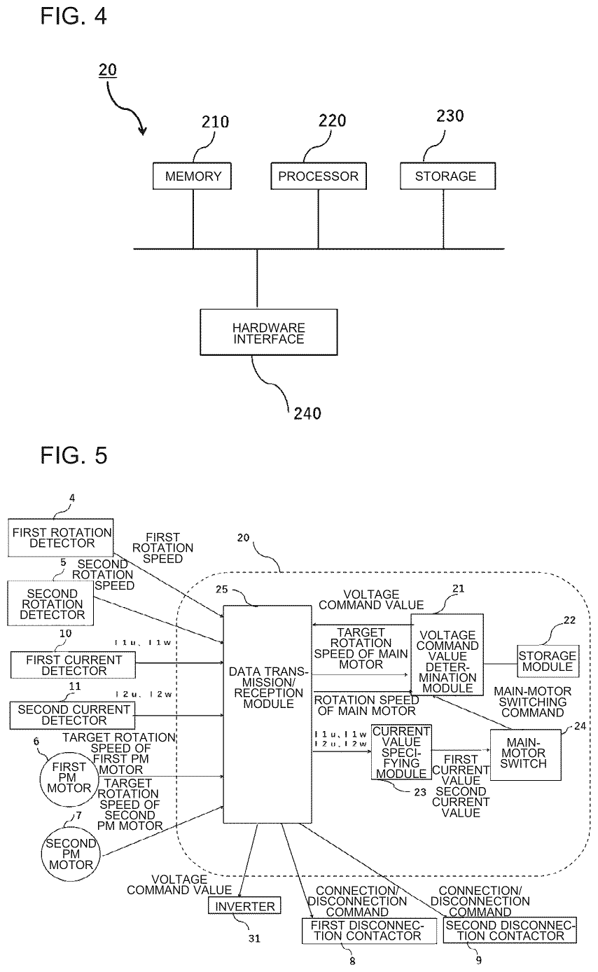

FIG. 4 is a block diagram illustrating a hardware configuration of the controller 20 included in the motor driving device 1 according to Embodiment 1. FIG. 5 is a block diagram illustrating a functional configuration of the controller 20 included in the motor driving device 1 according to Embodiment 1. The configuration of the controller 20 will be described with reference to FIGS. 4 and 5.

As illustrated in FIG. 4, the controller 20 includes a memory 210, a processor 220, a storage 230, and a hardware interface 240.

The memory 210 is configured to store a program that the processor 220 runs. In addition, the memory 210 is used as a workspace for the processor 220. The memory 210 is, for example, a volatile memory such as a random access memory (RAM) or a non-volatile memory such as a read only memory (ROM), or is a combination of both the volatile memory and the non-volatile memory.

The processor 220 is configured to run a program stored in the memory 210. Specifically, the processor 220 runs a program for determination of a voltage command value, a program for specifying a first current value that is the value of a current flowing in the first PM motor, and a second current value that is the value of a current flowing in the second PM motor, and a program for determination on whether or not to switch a main motor between the first PM motor 6 and the second PM motor 7. The main motor is either the first PM motor 6 or the second PM motor 7. The motor driving device 1 is configured to determine the voltage command value by performing a vector control regarding a rotation speed that is a parameter of the main motor. The processor 220 is, for example, a central processing module (CPU).

The parameter of the main motor is, for example, a rotation speed of the main motor, a d-axis inductance value of the main motor, a q-axis inductance value of the main motor, a current value of the main motor, or a motor winding resistance of the main motor. The parameter is not limited to one kind of information, and may be a combination of multiple information. In Embodiment 1, the rotation speed of the main motor is used as the parameter.

In Embodiment 1, the motor driving device 1 is configured to perform a vector control with encoder feedback. Specifically, the motor driving device 1 performs the vector control by comparing a target rotation speed of the main motor obtained from the first PM motor 6 or the second PM motor 7, with a rotation speed of the main motor detected by the first rotation detector 4 or the second rotation detector 5.

The storage 230 is configured to store a threshold for a current difference value that is the absolute value of the difference between the first current value and the second current value. The first current value is the value of the current flowing in the first PM motor 6. The second current value is the value of the current flowing in the second PM motor 7.

The storage 230 is, for example, a non-volatile memory, such as a solid state drive (SSD) or a read-only memory (ROM), or a hard disk.

The hardware interface 240 is configured to transmit or receive wirelessly or through wired connection, a signal to or from a hardware interface of the voltage conversion circuitry 3, the first PM motor 6, the second PM motor 7, the first disconnection contactor 8, the second disconnection contactor 9, the first current detector 10, the second current detector 11, the first rotation detector 4, or the second rotation detector 5.

Furthermore, as illustrated in FIG. 5, the controller 20 includes a voltage command value determination module 21, a storage module 22, a current value specifying module 23, a main-motor switch 24, and a data transmission/reception module 25.

The voltage command value determination module 21 is configured to determine a voltage command value for the voltage conversion circuitry 3 by using the vector control using the parameter of the main motor. More specifically, the voltage command value determination module 21 is configured to perform the vector control by comparing the target rotation speed of the main motor, which is either the first PM motor 6 or the second PM motor 7, with a detected rotation speed of the main motor to determine a voltage command value. The voltage command value determination module 21 is configured to transmit the determined voltage command value to the data transmission/reception module 25.

Furthermore, the voltage command value determination module 21 is configured to obtain the parameter of the main motor after switching, when receiving a main-motor switching command from the main-motor switch 24. The voltage command value determination module 21 is formed to include the memory 210 and the processor 220.

The storage module 22 is configured to store a threshold for a current difference value. The storage module 22 is a module in which information is stored in the storage 230.

The current value specifying module 23 is configured to specify the first current value that is the value of the current flowing in the first PM motor 6, and the second current value that is the value of the current flowing in the second PM motor 7.

The main-motor switch 24 is configured to determine whether or not it is necessary to perform switching between the main motor and a sub-motor based on the first current value and the second current value that are specified by the current value specifying module 23, and perform switching between the main current and the sub-motor. Specifically, the main-motor switch 24 is configured to determine that it is necessary to switch the main motor when the current difference value that is the absolute value of the difference between the first current value and the second current value is greater than the predetermined threshold stored in the storage module 22 and the current flowing in the sub-motor is greater than the current flowing in the main motor. That is, in the above case, when the first PM motor 6 is used as the main motor, the main motor is changed from the first motor 6 to the second PM motor 7; and when the second PM motor 7 is used as the main motor, the main motor is changed from the second PM motor 7 to the first PM motor 6. Furthermore, when the current difference value is less than or equal to the threshold stored in the storage module 22, or when the current flowing in the sub-motor is less than or equal to the current flowing in the main motor, switching of the main motor is not performed. In addition, the main-motor switch 24 is configured to transmit a main-motor switching command to the voltage command value determination module 21. The main-motor switch 24 is formed to include the memory 210 and the processor 220.

The data transmission/reception module 25 is configured to transmit a signal from the controller 20 or receive a signal to be transmitted to the controller 20. More specifically, the data transmission/reception module 25 receives, from the first current detector 10, a signal including an instantaneous value I1u of the current in the first U-phase power line and an instantaneous value I1w of the current in the first W-phase power line; receives, from the second current detector 11, a signal including an instantaneous value I2u of the current in the second U-phase power line and an instantaneous value I2w of the current in the second W-phase power line; receives a signal including the target rotation speed of the main motor from the first PM motor 6 or the second PM motor 7; and receives a signal including a detected rotation speed of the main motor from the first rotation detector 4 or the second rotation detector 5.

Furthermore, the data transmission/reception module 25 is configured to transmit, to the voltage conversion circuitry 3, a signal including a voltage command value determined by the voltage command value determination module 21; transmit a signal including a connection or disconnection command to the first disconnection contactor 8, transmit a signal including a connection or disconnection command to the second disconnection contactor 9; and transmit a signal including a drive or stop command to each of the first PM motor 6, the second PM motor 7, and the inverter 31. Moreover, the data transmission/reception module 25 is capable of transmitting and receiving data to and from each of components of the controller 20. The data transmission/reception module 25 is the hardware interface 240.

The first PM motor 6 and the second PM motor 7 are configured to drive the first fan 123 and the second fan 124, respectively, in the outdoor heat exchanger 104, and are fixedly installed outdoors. Therefore, a difference between the load on the first PM motor 6 and that on the second PM motor 7 may be made due to the installation environment or characteristics. As an installation environment where the load increases, the following environment is present: a heating element is located close to a location where a motor is set or a gust wind blows at the location where the motor is set.

Due to factors described above, the load on the sub-motor may become higher than that on the main motor. In such a case, the rotation speed of the sub-motor may fail to reach the target rotation speed. Then, if the rotational speed of the sub-motor deviates from a control range, a problem arises in which an out-of-step condition occurs in the control.

In the motor driving device 1 of Embodiment 1, switching between the main motor and the sub-motor is performed when the current difference value is greater than the predetermined threshold and the current flowing in the sub-motor is greater than the current flowing in the main motor. With such a configuration, it is possible to use, as the main motor, one of the motors to which a greater load is applied, and thus reduce occurrence of an out-of-step condition in the control.

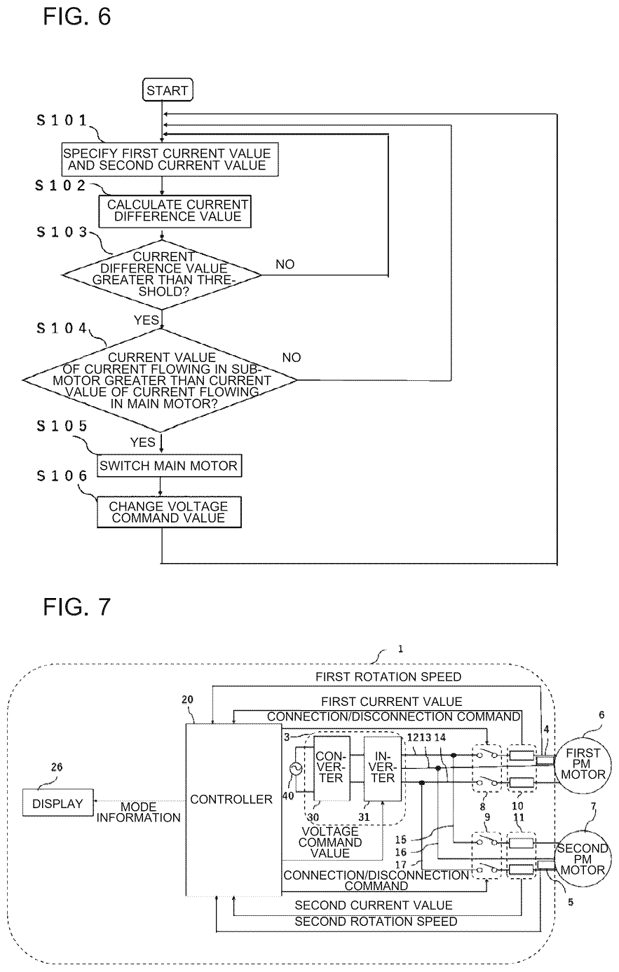

FIG. 6 is a flowchart of a main-motor switching determination processing by the controller 20 included in the motor driving device 1 according to Embodiment 1. The processing by the controller will be described with reference to FIG. 6. When determining that a detected rotation speed of the main motor that is obtained by the voltage command value determination module 21 reaches the target rotation speed, the controller 20 starts the main-motor switching determination processing.

When it is determined that the detected rotation speed of the main motor that is obtained by the voltage command value determination module 21 reaches the target rotation speed of the main motor, the process of step S101 is started. In step S101, the current value specifying module 23 of the controller 20 specifies the first current value that is the value of the current flowing in the first PM motor 6 from an instantaneous value of the current that is detected by the first current detector 10, and the second current value that is the value of the current flowing in the second PM motor 7 from an instantaneous value of the current that is detected by the second current detector 11. The process of step S101 ends when the current value specifying module 23 specifies the first current value and the second current value.

The process of step S102 is executed after the process of step S101. In step S102, the main-motor switch 24 of the controller 20 calculates a current difference value. The current difference value is the absolute value of the difference between the first current value and the second current value that are specified in step S101. The process of step S102 ends when the main-motor switch 24 calculates the current difference value.

The process of step S103 is executed after the process of step S102. In step S103, the main-motor switch 24 of the controller 20 determines whether or not the current difference value calculated in step S102 is greater than the threshold that is stored as data in advance in the storage module 22. The process of step S103 ends when the main-motor switch 24 determines whether or not a condition is satisfied.

When it is determined in step S103 that the current difference value is not greater than the threshold (No in step S103), the current value specifying module 23 carries out step S101.

The process of step S104 is executed when it is determined in step S103 that the current difference value is greater than the threshold (Yes in step S103). In step S104, the main-motor switch 24 of the controller 20 determines whether the value of the current flowing in the sub-motor that is determined in step S101 is greater than the value of the current flowing in the main motor that is determined in step S101. In step S104, when the first PM motor 6 is the main motor, the main-motor switch 24 determines whether or not the second current value is greater than the first current value. When the second PM motor 7 is the main motor, the main-motor switch 24 determines whether or not the first current value is greater than the second current value. The process of step S104 ends when the main-motor switch 24 determines whether or not the condition is satisfied.

When it is determined in step S104 that the current value of the current flowing in the sub-motor is not greater than the current value of the current flowing in the main motor (No in step S104), the current value specifying module 23 carries out step S101.

The process of step S105 is carried out when it is determined in step S104 that the current value of the current flowing in the sub-motor is greater than the current value of the current flowing in the main motor (Yes in step S104). In step S105, the main-motor switch 24 of the controller 20 switches the main motor. That is, in the case where the first PM motor 6 is used as the main motor, the main motor is switched from the first PM motor 6 to the second PM motor 7; and in the case where the second PM motor 7 is used as the main motor, the main motor is switched from the second PM motor 7 to the first PM motor 6. In step S105, the main-motor switch 24 transmits a signal including a main motor switch command to the voltage command value determination module 21. The process of step S105 ends when the main-motor switch 24 switches the main motor.

The process of step S106 is executed after the process of step S105. In step S106, the voltage command value determination module 21 of the controller 20 changes the voltage command value. Specifically, the voltage command value determination module 21 determines the voltage command value by performing the vector control regarding the rotation speed of the main motor, which is the parameter of the motor determined as the main motor after switching in step S105. The process of step S106 ends, when the voltage command value determination module 21 determines that the detected rotation speed of the main motor reaches the target rotation speed of the main motor and determines the voltage command value.

After the process of step S106, the current value specifying module 23 carries out step S101.

As described above, the motor driving device 1 according to Embodiment 1 includes the voltage conversion circuitry 3 configured to apply to the first motor (corresponding to the first PM motor 6) and the second motor (corresponding to the second PM motor 7), a converted AC voltage obtained by converting an AC voltage output from the AC power source 40 based on the voltage command value, and a controller (corresponding to the controller 20) configured to determine the voltage command value based on the parameter of the first motor, when the first current value of the current flowing in the first motor is greater than the second current value of the current flowing in the second motor and the current difference value that is the absolute value of the difference between the first current value and the second current value is greater than the predetermined threshold, and determine the voltage command value P03140 based on the parameter of the second motor, when the second current value is greater than the first current value and the current difference value is greater than the threshold. With this configuration, the motor driving device 1 according to Embodiment 1 can reduce occurrence of the out-of-step condition.

In addition, the motor driving method according to Embodiment 1 includes: a first step of obtaining the first current value that is applied to the first motor (corresponding to the first PM motor 6) and the second current value that is applied to the second motor (corresponding to the second PM motor 7); a second step of calculating the current difference value that is the absolute value of the difference between the first current value and the second current value both obtained in the first step; a third step of using the second motor as the main motor when the second current value is greater than the first current value and the current difference value is greater than the predetermined threshold, and using the first motor as the main motor when the first current value is greater than the second current value and the current difference value is greater than the threshold; and a fourth step of applying to the first motor and second motor, a converted AC voltage obtained by converting an AC voltage output from the AC power source 40 based on a voltage command value, which is determined based on the parameter of the main motor that is determined in the third step, With this configuration, the motor driving method according to Embodiment 1 can reduce occurrence of the out-of-step condition.

Furthermore, the refrigeration cycle apparatus 100 according to Embodiment 1 includes: the compressor 102; the outdoor heat exchanger 104 including the first outdoor heat exchanger 121 that is provided with the first motor (corresponding to the first PM motor 6) and the second outdoor heat exchanger 122 that is provided with the second motor (corresponding to the second PM motor 7) and connected in the refrigerant circuit in parallel with the first outdoor heat exchanger 121; the pressure reducing device 103; the indoor heat exchanger 201, refrigerant pipes (corresponding to the pipes 301) that connect the compressor 102, the outdoor heat exchanger 104, the pressure reducing device 103, and the indoor heat exchanger 201 so that refrigerant circulates through these devices; and the motor driving device 1 including the voltage conversion circuitry 3 configured to apply a converted AC voltage, which is obtained by converting an AC voltage output from the AC power source 40 based on the voltage command value, to the first motor and the second motor, and the controller (corresponding to the controller 20) configured to determine a voltage command value based on the parameter of the second motor, when the second current value that is the value of the current flowing in the second motor is greater than the first current value that is the value of the current flowing in the first motor and the current difference value that is the absolute value of the difference between the first current value and the second current value is greater than the predetermined threshold, and determine a voltage command value based on the parameter of the first motor, when the first current value is greater than the second current value and the current difference value is greater than the threshold. With this configuration, the refrigeration cycle apparatus 100 according to Embodiment 1 can reduce occurrence of the out-of-step condition.

As an additional configuration of the motor driving device 1 according to Embodiment 1, the first current value is an instantaneous value of the current flowing in the first motor (corresponding to the first PM motor 6) and the second current value is an instantaneous value of the current flowing in the second motor (corresponding to the second PM motor 7). With this additional configuration, the motor driving device 1 according to Embodiment 1 can promptly perform a motor driving control.

As another additional configuration of the motor driving device 1 according to Embodiment 1, the parameter includes the rotation speed of a motor. With this additional configuration, the motor driving device 1 according to Embodiment 1 can perform an appropriate control based on driving states of the motors.

As a further additional configuration, in the motor driving device 1 according to Embodiment 1, the first motor (corresponding to the first PM motor 6) and the second motor (corresponding to the second PM motor 7) are three-phase AC motors, and the voltage conversion circuitry 3 includes the converter 30 configured to convert an AC voltage output from the AC power source 40 into a DC voltage and the inverter 31 configured to apply to the first motor and the second motor, a three-phase AC voltage into which the DC voltage obtained by conversion performed by the converter 30 is converted based on the voltage command value. With this additional configuration, the motor driving device 1 according to Embodiment 1 can drive the motors with low electrical losses.

As yet another additional configuration, the motor driving device 1 according to Embodiment 1 determines the first current value by detecting current values of two or more phases of the first motor (corresponding to the first PM motor 6) and determines the second current value by detecting current values of two or more phases of the second motor (corresponding to the second PM motor 7). With this additional configuration, the motor driving device 1 according to Embodiment 1 can detect current values of all three phases in each of the three-phase AC motors.

Furthermore, as still another additional configuration, in the motor driving device 1 according to Embodiment 1, the controller (corresponding to the controller 20) is configured to determine the voltage command value by performing a vector control based on the parameter of one of the first motor (corresponding to the first PM motor 6) and the second motor (corresponding to the second PM motor 7). With this additional configuration, the motor driving device 1 according to Embodiment 1 can perform the control in consideration of not only the magnitude of a voltage and the frequency but also the direction in which the current is made to flow.

Furthermore, as an additional configuration of the motor driving method according to Embodiment 1, the first current value obtained in the first step is an instantaneous value of the current flowing in the first motor (corresponding to the first PM motor 6) and the second current value is an instantaneous value of the current flowing in the second motor (corresponding to the second PM motor 7). With this additional configuration, the motor driving method according to Embodiment 1 can promptly perform a motor driving control.

Furthermore, as another additional configuration, in the motor driving method according to Embodiment 1, the first motor (corresponding to the first PM motor 6) and the second motor (corresponding to the second PM motor 7) are three-phase AC motors, and the voltage conversion circuitry 3 includes the converter 30 configured to convert an AC voltage output from the AC power source 40 into a DC voltage and the inverter 31 configured to apply to the first motor and the second motor, a three-phase AC voltage into which the DC voltage obtained by conversion performed by the converter 30 is converted based on the voltage command value. With this additional configuration, the motor driving method according to Embodiment 1 enables the motors to be driven with low electrical losses.

Furthermore, as a further additional configuration, in the motor driving method according to Embodiment 1, the first current value obtained in the first step is determined by detection of current values of two or more phases of the first motor (corresponding to the first PM motor 6) and the second current value is determined by detection of current values of two or more phases of the second motor (corresponding to the second PM motor 7). With this additional configuration, the motor driving method according to Embodiment 1 enables current values of all the three phases of each of the three-phase AC motors to be detected.

Furthermore, as a yet another additional configuration, in the motor driving method according to Embodiment 1, the controller (corresponding to the controller 20) is configured to determine the voltage command value in the fourth step by performing the vector control based on the parameter of one of the first motor (corresponding to the first PM motor 6) and the second motor (corresponding to the second PM motor 7). With this additional configuration, the motor driving method according to Embodiment 1 enables the control to be performed in consideration of not only the magnitude of the voltage and the frequency but also the direction in which the current is made to flow.

Furthermore, as an additional configuration of the refrigeration cycle apparatus 100 according to Embodiment 1, the first current value is an instantaneous value of the current flowing in the first motor (corresponding to the first PM motor 6) and the second current value is an instantaneous value of the current flowing in the second motor (corresponding to the second PM motor 7). With this additional configuration, the refrigeration cycle apparatus 100 according to Embodiment 1 can promptly perform the motor driving control.

Furthermore, as another additional configuration of the refrigeration cycle apparatus 100 according to Embodiment 1, the parameter includes the rotation speed of each of the motors. With this additional configuration, the refrigeration cycle apparatus 100 according to Embodiment 1 can perform an appropriate control based on driving states of the motors.

Furthermore, as a further additional configuration, in the refrigeration cycle apparatus 100 according to Embodiment 1, the first motor (corresponding to the first PM motor 6) and the second motor (corresponding to the second PM motor 7) are three-phase AC motors, and the voltage conversion circuitry 3 includes the converter 30 configured to convert an AC voltage output from the AC power source 40 into a DC voltage and the inverter 31 configured to apply to the first motor and the second motor, a three-phase AC voltage into which the DC voltage obtained by conversion performed by the converter 30 is converted based on the voltage command value. With this additional configuration, the refrigeration cycle apparatus 100 according to Embodiment 1 can drive the motors with low electrical losses.

Moreover, as yet another additional configuration, in the refrigeration cycle apparatus 100 according to Embodiment 1, the first current value is determined by detecting current values of two or more phases of the first motor (corresponding to the first PM motor 6) and the second current value is determined by detecting current values of two or more phases of the second motor (corresponding to the second PM motor 7). With this additional configuration, the refrigeration cycle apparatus 100 according to Embodiment 1 is capable of detecting current values of all the three phases of each of the three-phase AC motors.

In addition, as still another additional configuration, in the motor driving device 1 according to Embodiment 1, the controller (corresponding to the controller 20) is configured to determine the voltage command value by performing the vector control based on the parameter of one of the first motor (corresponding to the first PM motor 6) and the second motor (corresponding to the second PM motor 7). With this additional configuration, the refrigeration cycle apparatus 100 according to Embodiment 1 can perform the control in consideration of not only the magnitude of the voltage and the frequency but also the direction in which the current is made to flow.

It should be noted that in Embodiment 1, the outdoor heat exchangers are of a top-flow type but their types, but this is not limiting, and may be, for example, of a side-flow type.

In Embodiment 1, the motor driving device is incorporated in the first outdoor heat exchanger, but this is not limiting. The motor driving device may be incorporated in the second outdoor heat exchanger or may be provided outside the outdoor heat exchangers as a separate device.

In Embodiment 1, the motor driving device is configured to drive the motors of the outdoor heat exchangers but this is not limiting. For example, the motor driving device may be configured to drive the motor of the indoor heat exchanger. In addition, the motor driving device may be configured to drive a motor of an apparatus other than the refrigeration cycle apparatus.

Furthermore, the first PM motor is provided in the first outdoor heat exchanger and the second PM motor is provided in the second outdoor heat exchanger, but this is not limiting. For example, both the first PM motor and the second PM motor may be provided in one of the outdoor heat exchangers.

Moreover, in Embodiment 1, current detectors and disconnection contactors are inserted into two of the three power lines connected to each of the motors, but this is not limiting. For example, the current detectors and the disconnection contactors may be inserted into all of the three power lines.

In Embodiment 1, disconnection contactors are inserted into the power lines connected to the first PM motor and the power lines connected the second PM motor, but this is not limiting. Disconnection contactors may be inserted into only power lines connected to the first PM motor or may be inserted into only power lines connected to the second PM motor. Also, with this configuration, it is possible to drive only one of the motors by disconnecting the power lines connected to the other motor therefrom. In addition, the motor driving device may be configured to have no disconnection contactor.

In Embodiment 1, the motor driving device is configured to determine the voltage command value by performing the vector control using the parameter of the main motor, but this is not limiting. For example, the motor driving device may configured to perform a V/f control or may be configured to determine the voltage command value by performing the control using a position detection by a Hall sensor.

In Embodiment 1, the inverter is configured to output a three-phase AC voltage, but this is not limiting. For example, the inverter may be configured to output a single-phase AC voltage.

In Embodiment 1, the motor driving device is configured to perform a control over two motors, but this is not limiting. The motor driving device may be configured to perform a control over two or more motors. In the case where the motor driving device perform the control over three or more motors, multiple sub-motors are provided.

In Embodiment 1, the motor driving device is configured to control the PM motors, but this is not limiting. For example, the motors that the motor driving device controls may be induction motors.

In Embodiment 1, the main-motor switching module is configured to switch the main motor while keeping the motors and the inverter in operation, but this is not limiting. The main-motor switching module may be configured to temporarily stop the motors when switching the main motor. In a configuration in which the main-motor switching module temporarily stop the motors when switching the main motor, it is possible to prevent an instantaneous increase of the current.

In Embodiment 1, the current difference value is calculated from an instantaneous value of the current flowing in the first PM motor and that of the current flowing in the second PM motor, but this is not limiting. For example, the current difference value may be calculated from the value of a torque current component (q-axis) of the current flowing in the first PM motor and that of the current flowing in the second PM motor. In a configuration in which the current difference value is calculated from the values of torque current components, a prompt torque control can be performed. In addition, the average value of the amplitudes of currents in a predetermined time period may be used instead of the instantaneous values of the currents.

In Embodiment 1, the current value of current flowing in the sub-motor and the current value of current flowing in the main motor are compared with each other after the current difference value is compared with the threshold, but this is not limiting. The current difference value may be compared with the threshold after the current value of current flowing in the sub-motor and the current value of current flowing in the main motor are compared.

### Embodiment 2

A motor driving device 2 according to Embodiment 2 will be described. The motor driving device 2 according to Embodiment 2 has a different configuration from that of Embodiment 1. Because the outline of the refrigeration cycle apparatus 100 including the motor driving device 2 according to Embodiment 2 and the configuration of the outdoor heat exchanger 104 are the same as those of Embodiment 1, their descriptions will thus be omitted.

FIG. 7 is a schematic view illustrating a configuration of the motor driving device 2 according to Embodiment 2. The configuration of the motor driving device 2 will be described with reference to FIG. 7.

In the motor driving device 2, the first PM motor 6 and the second PM motor 7 are operated in one of two operation modes. Furthermore, the motor driving device 2 is provided with a display 26. On these points, the configuration of the motor driving device 2 differs from that of the motor driving device 1. Except for the operation modes of the first PM motor 6 and the second PM motor 7 and the display 26, the configuration of the motor driving device 2 is the same as that of the motor driving device 1 and its description will thus be omitted.

The first PM motor 6 and the second PM motor 7 are operated in either a normal operation mode or an emergency operation mode. The first PM motor 6 and the second PM motor 7 are operated in the normal operation mode at a start-up time and when it is determined that no abnormality occurs in the main motor. In the normal operation mode, the first PM motor 6 and the second PM motor 7 are vector controlled using parameters of the motor being set as the main motor, and are thus operated at a designed rated frequency and are vector controlled using the parameters of the motor being set as the main motor.

When it is determined that an abnormality occurs in the main motor, the first PM motor 6 and the second PM motor 7 are operated in the emergency operation mode. In the emergency operation mode, the first PM motor and the second PM motor 7 are operated in a stable frequency band, which is lower than the designed rated frequency. In addition, in the emergency operation mode, the values of the parameters of the main motor, which are used to determine the voltage command values for the voltages flowing in the first PM motor 6 and the second PM motor 7, is changed.

The parameters of the main motor in Embodiment 2 are the rotation speed, d-axis inductance value, and q-axis inductance value of the main motor.

In the emergency operation mode, the values of the parameters of the main motor are changed based on the current value of the current flowing in the main motor. More specifically, in the emergency operation mode, the target rotation speed of the main motor is set to a lower value, and the d-axis and q-axis inductance values of the main motor are set to smaller values than those set in the normal operation mode.

The display 26 is configured to display mode information. The mode information is information received from a controller 50 and indicates an operation state of each of the motors. Specifically, the display 26 indicates that an inverter 41 is operated in the normal operation mode or the emergency operation mode.

Because the motor driving device 2 according to Embodiment 2 is provided with the display 26, the motor driving device 2 can notify an operator of the operation state of the motor.

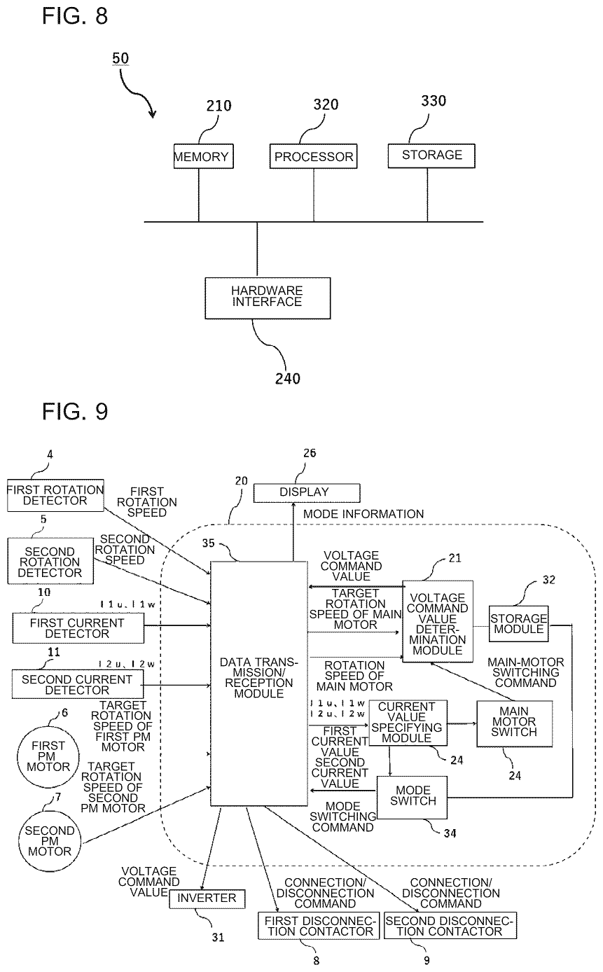

FIG. 8 is a block diagram illustrating a hardware configuration of the controller 50 included in the motor driving device 2 according to Embodiment 2. FIG. 9 is a block diagram illustrating a functional configuration of the controller 50 included in the motor driving device 2 according to Embodiment 2. The configuration of the controller 50 will be described with reference to FIGS. 8 and 9.

The hardware configuration of the controller 50 differs from that in Embodiment 1 regarding the program to be run by a processor 320 and information stored in a storage 330. Except for the program to be run by the processor 320 and the information stored in the storage 330, the configuration of the controller 50 is the same as that of the controller 20, and its description will thus be omitted.

The processor 320 is configured to run a program to determine a voltage command value, a program to specify a first current value that is the value of a current flowing in the first PM motor 6 and a second current value that is the value of a current flowing in the second PM motor 7, a program to determine whether or not to switch the main motor, and a program to determine whether or not to switch the operation mode of the first PM motor 6 and that of the second PM motor 7.

The storage 330 is configured to store a threshold for a current difference value, an allowable current value, and a main-motor switching count value. The allowable current value is a current value associated with the voltage command value, and indicates an upper limit of the current value in the case where an abnormality does not occur in the motor. In addition, the allowable current value is determined as an arbitrary value based on the result of experiment or simulation performed by a designer of the motor driving device 1. The main-motor switching count indicates the number of times the switching between the main motor and the sub-motor is performed. The count is zero during the driving of the motor.

The functional configuration of the controller 50 differs from that of Embodiment 1 regarding contents stored in a storage module 32, whether or not the controller 50 is provided with a mode switch 34, and a signal that a data transmission/reception module 35 transmits. Except for the contents stored in the storage module 32 and the configurations of the mode switch 34 and the data transmission/reception module 35, the configuration of the controller 50 is the same as that of the controller 20 and its description will thus be omitted.

The storage module 32 is configured to store the threshold for the current difference value, the allowable current value, and the main-motor switching count.

The mode switch 34 is configured to determine whether to switch the operation mode of the first PM motor 6 and that of the second PM motor 7 by determining whether or not the current value of the main motor is less than or equal to the allowable current value corresponding to the voltage command value. More specifically, the mode switch 34 caused the first PM motor 6 and the second PM motor 7 to operate in the normal operation mode, when the current value of the main motor is less than or equal to the allowable current value corresponding to the voltage command value. In addition, the mode switch 34 caused the first PM motor 6 and the second PM motor 7 to operate in the emergency operation mode when the current value of the main motor is greater than the allowable current value corresponding to the voltage command value.

The data transmission/reception module 35 is configured to transmit a signal including mode information to the display 26. In this regard, the data transmission/reception module 35 differs from that of Embodiment 1

By performing the main-motor switching determination processing described regarding Embodiment 1, the motor driving device 2 can perform the control using one of the motors to which a load is applied, as the main motor. With this processing, it is possible to reduce occurrence of the out-of-step condition.

However, if an abnormality occurs in the motor, switching the main motor alone may not be sufficient. For example, if the main motor is demagnetized, it is not appropriate to perform the control using the set parameters of the motor. This is because the magnetic force of the main motor becomes weaker than when the parameters are set.

In Embodiment 2, the motor driving device 2 is configured to perform, in addition to the processing of switching the main motor, processing for switching the operation mode of the motor into the emergency operation mode, when it is determined that an abnormality occurs in the motor. Thus, even when an abnormality occurs in the motor, the motor driving device 2 can perform an operation in consideration of the abnormality.

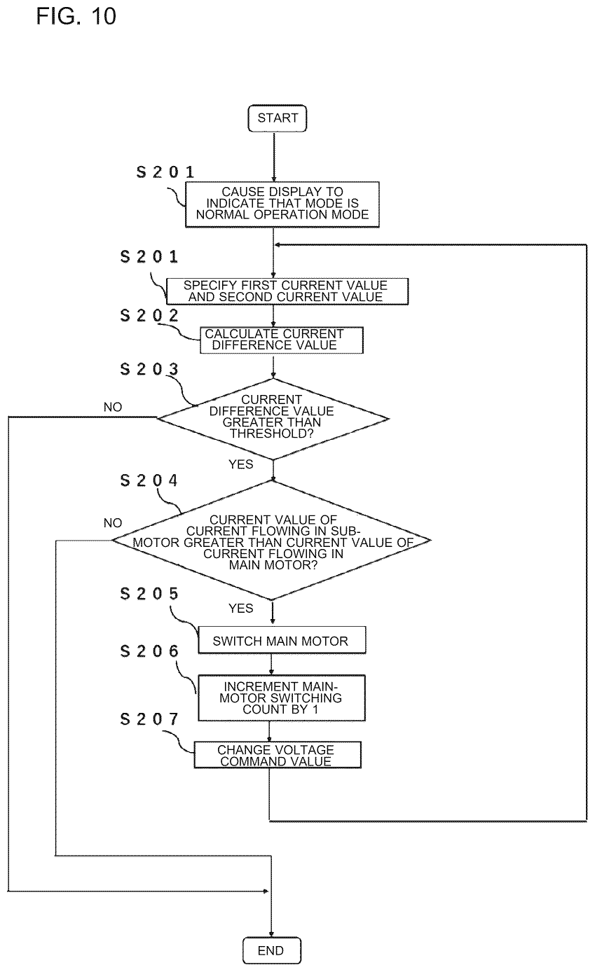

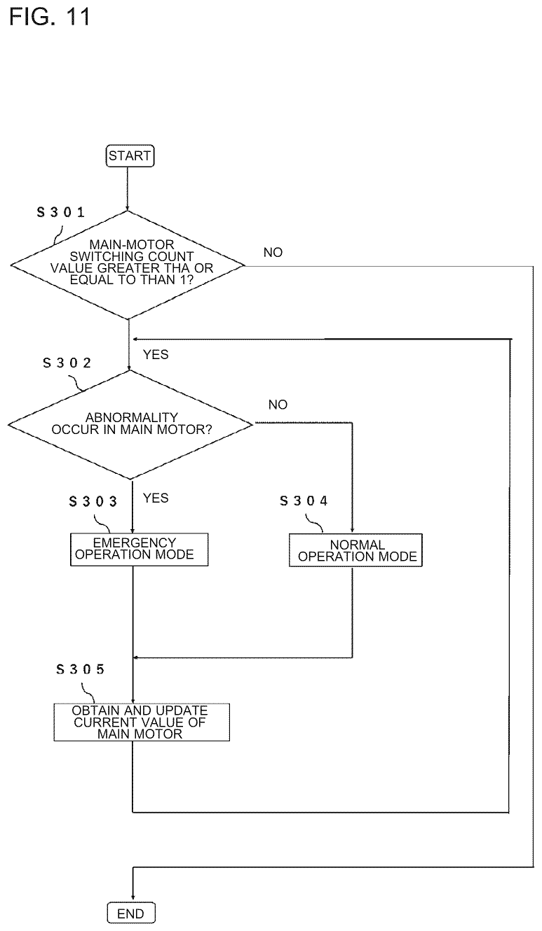

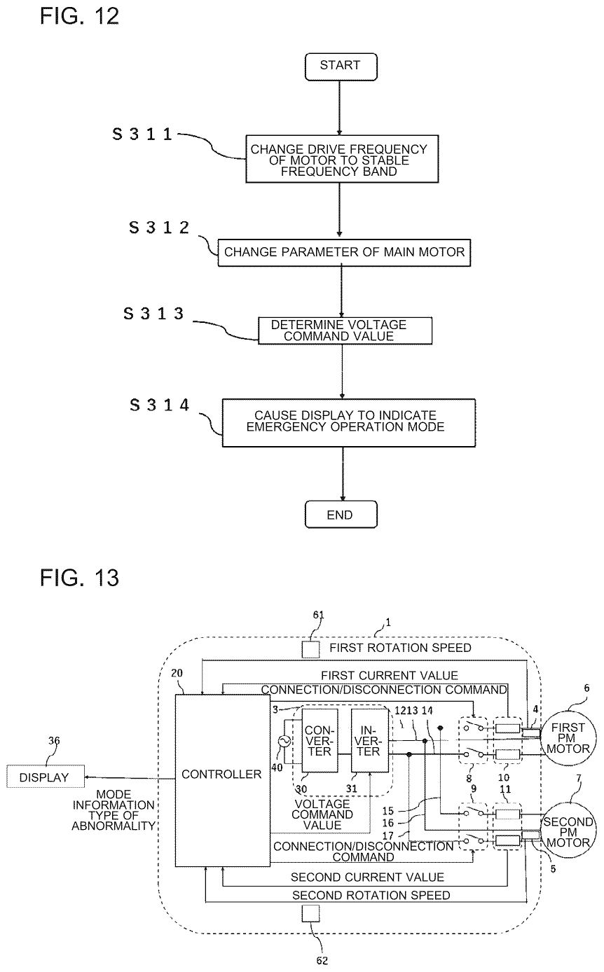

FIG. 10 is a flowchart illustrating a main-motor switching determination processing by the controller 50 included in the motor driving device 2 according to Embodiment 2. FIG. 11 is a flowchart illustrating a mode switching determination processing by the controller 50 included in the motor driving device 2 according to Embodiment 2. FIG. 12 is a flowchart illustrating processing in the emergency operation mode in the mode switching determination processing by the controller 50 included in the motor driving device 2 according to Embodiment 2. FIG. 12 is a flowchart for detailed explanation of step S304 indicated in FIG. 11. The processing by the controller 50 will be described with reference to FIGS. 10 to 12.

In the main-motor switching determination processing of Embodiment 2, the processing is ended when the main-motor switch 24 of the controller 50 determines that switching of the main motor is not needed, and the storage module 32 stores the main-motor switching count value. On these points, the main-motor switching determination processing of Embodiment 2 differs from that of Embodiment 1. In addition, unlike Embodiment 1, the controller 50 of Embodiment 2 starts the mode switching determination processing when the main-motor switching determination processing ends.

The controller 50 starts the main-motor switching determination processing as Illustrated in FIG. 10, when the voltage command value determination module 21 determines that a detected rotation speed of the main motor reaches the target rotation speed.

The process of step S201 is started when the voltage command value determination module 21 determines that the detected rotation speed of the main motor reaches the target rotation speed. In step S201, the data transmission/reception module 35 transmits, to the display 26, a signal including a signal indicating that the first PM motor 6 and the second PM motor 7 are operated in the normal operation mode.

The process of step S201 is ended when the data transmission/reception module 35 transmits a signal indicating that the operation is performed in the normal operation mode to the display 26.

The process of step S202 is executed after the process of step S201. Because the processes of steps S202 to S206 are the same as those of steps S101 to S105 according to Embodiment 1, their descriptions will be omitted. The process of step S205 is ended when the main-motor switch 24 determines whether or not the condition is satisfied.

The process of step S207 is executed after the process of step S206. In step S207, the storage module 32 updates the main-motor switching count value stored therein by incrementing the value by one. The process of step S207 is ended when the storage module 32 updates the main-motor switching count value.

The process of step S208 is executed after the process of step S207. Because the process of step S208 is the same as that of step S106 according to Embodiment 1, its description will be omitted. The processing of S208 is ended when the voltage command value determination module 21 determines that a detected rotation speed of the main motor reaches the target rotation speed of the main motor and determines the voltage command value.

The main-motor switching determination processing by the controller 50 is ended when it is determined in step S204 that the current difference value is not greater than the threshold (No in step S204) or when it is determined in step S205 that the current value flowing in the sub-motor is not greater than the current value flowing in the main motor (No in step S205).

When the main-motor switching determination processing is ended, the controller 50 starts the mode switching determination processing as illustrated in FIG. 11.

The process of step S301 is executed after the main-motor switching determination processing is ended. In step S301, the mode switch 34 of the controller 50 determines whether or not the main-motor switching count stored in the storage module 32 is greater than or equal to one. The process of step S301 is ended when the mode switch 34 determines whether or not the condition is satisfied.

The process of step S302 is executed after the process of step S301. In step S302, the mode switch 34 of the controller 50 determines whether or not an abnormality occurs in the main motor. More specifically, the mode switch 34 determines whether or not the current value of the main motor specified in step S201 is less than or equal to the allowable current value corresponding to the voltage command value stored in the storage module 32. The process of step S302 is ended when the mode switch 34 determines whether or not the condition is satisfied.

The process of step S303 is executed after it is determined in step S302 that an abnormality occurs in the main motor (Yes in step S302). In step S303, the mode switch 34 of the controller 50 causes the first PM motor 6 and the second PM motor 7 to operate in the emergency operation mode. More specifically, in the process of step S303, the processes of steps S311 to S314 are executed, as illustrated in FIG. 12. The processing of each of steps S311 to S314 will be described below.

The process of step S311 is executed when it is determined in step S302 that an abnormality occurs in the main motor (Yes in step S302). In step S311, the mode switch 34 of the controller 50 changes the driving frequencies of the main motor and the sub-motor to frequencies in a stable frequency band, which are frequencies lower than a designed rated frequency. The process of step S311 is ended when the mode switch 34 changes the frequencies.

The process of step S312 is executed after the process of step S311. In step S312, the mode switch 34 of the controller 50 changes the parameters of the main motor. More specifically, the mode switch 34 changes the parameters of the main motor by reducing the target rotation speed of the main motor and reducing the d-axis and q-axis inductance values of the main motor such that they are lower than the values that are set during driving of the motor. In addition, the mode switch 34 changes the parameters of the main motor that are stored in the storage module 32 by overwriting. The process of step S312 is ended when the mode switch 34 changes the parameters of the main motor.

The process of step S313 is executed after the process of step S312. In step S313, the voltage command value determination module 21 of the controller 50 determines the voltage command value based on the parameters of the main motor that are changed in step S312. The process of step S313 is ended when the voltage command value determination module 21 determines the voltage command value.

The process of step S314 is executed after the process of step S313. In step S314, the data transmission/reception module 35 of the controller 50 transmits, to the display 26, a signal including a signal indicating that the first PM motor 6 and the second PM motor 7 are operated in the emergency operation mode. The process of step S314 is ended when the data transmission/reception module 35 transmits, to the display 26, a signal indicating that the operation is performed in the emergency operation mode.

The process of step S303 is ended when step S314 is ended.

The process of step S304 is carried out when it is determined in step S302 that an abnormality does not occur in the main motor (No in step S302). In step S304, the mode switch 34 of the controller 50 causes the first PM motor 6 and the second PM motor 7 to operate in the normal operation mode. More specifically, the mode switch 34 causes the first PM motor and the second PM motor 7 to operate at a set rated frequency and based on the parameters of the main motor that are stored in the storage module 32. The process of step S304 is ended when the mode switch 34 causes the first PM motor 6 and the second PM motor 7 to operate in the normal operation mode.

The process of step S305 is executed after the process of step S303 or the process of step S304. In step S305, the current value specifying module 23 of the controller 50 specifies a value of the current flowing in the main motor from an instantaneous value of the current detected by the first current detector 10 or the second current detector 11, and updates the current value of the main motor. The process of step S305 is ended when the current value specifying module 23 obtains and updates the current value flowing in the main motor.

After the process of step S305, the mode switch 34 carries out step S302. That is, when the main motor switching processing is executed once or more, the controller 50 constantly carries out steps S302 to 305 while the motors are in operation.

The mode switching determination processing by the controller 50 is ended when it is determined in step S301 that the main-motor switching count value is less than one, that is, it is zero (No in step S301). In the case where the main motor is not switched, the load on the main motor is higher than that on the sub-motor or the difference between the load on the main motor and that on the sub-motor is small. This is because it is unlikely that the out-of-step condition will occur in the control, even when neither the driving frequencies of the motors nor the parameters of the main motor are changed.

It should be noted that in Embodiment 2, the display module is configured to display the operation mode of the motor, but this is not limiting. For example, the display module may be configured to display the main motor or to display parameters of the main motor. A configuration in which no display module is provided may be applied.

In addition, in Embodiment 2, when the main-motor switching count is one or greater, the processing to be executed is unchanged; however, this is not limiting. For example, in the case where the main-motor switching count is two or more, the motors may be operated in the emergency operation mode. In such a case, since switching of the main motor is performed two or more times, it is highly likely that an abnormality occurs in the motor during the operation thereof.

Furthermore, the parameters of the main motor in Embodiment 2 are the rotation speed, d-axis inductance value, and q-axis inductance value of the main motor, but this is not limiting. For example, the parameter of the main motor may be only the d-axis inductance value.

As described above, the motor driving device 2 according to Embodiment 2 includes the voltage conversion circuitry 3 configured to apply to the first motor (corresponding to the first PM motor 6) and the second motor (corresponding to the second PM motor 7), a converted AC voltage obtained by converting an AC voltage output from the AC power source 40 based on a voltage command value, and a controller (corresponding to the controller 50) configured to determine a voltage command value based on the parameter of the first motor when the first current value that is the value of the current flowing in the first motor is greater than the second current value that is the value of the current flowing in the second motor and the current difference value that is the absolute value of the difference between the first current value and the second current value is greater than the predetermined threshold, and to determine the voltage command value based on the parameter of the second motor when the second current value is greater than the first current value and the current difference value is greater than the threshold. With this configuration, the motor driving device 2 according to Embodiment 2 obtains the same advantages as described regarding Embodiment 1.

In addition, the motor driving method according to Embodiment 2 includes: a first step of obtaining the first current value that is applied to the first motor (corresponding to the first PM motor 6) and the second current value that is applied to the second motor (corresponding to the second PM motor 7); a second step of calculating the current difference value that is the absolute value of the difference between the first current value and the second current value both obtained in the first step; a third step of using the second motor as the main motor when the second current value is greater than the first current value and the current difference value is greater than the predetermined threshold, and of using the first motor as the main motor when the first current value is greater than the second current value and the current difference value is greater than the threshold; and a fourth step of applying to the first motor and the second motor, a converted AC voltage, which is obtained by converting an AC voltage output from the AC power source 40 based on the voltage command value determined based on the parameter of the main motor that is determined in the third step. With this configuration, the motor driving method according to Embodiment 2 obtains the same advantages as described regarding Embodiment 1.

Furthermore, the refrigeration cycle apparatus according to Embodiment 2 includes: the compressor 102; the outdoor heat exchanger 104 including the first outdoor heat exchanger 121 that is provided with the first motor (corresponding to the first PM motor 6) and the second outdoor heat exchanger 122 that is provided with the second motor (corresponding to the second PM motor 7) and is connected in a refrigerant circuit in parallel with the first outdoor heat exchanger 121; the pressure reducing device 103; the indoor heat exchanger 201; the refrigerant pipes (corresponding to the pipes 301) that connect the compressor 102, the outdoor heat exchanger 104, the pressure reducing device 103, and the indoor heat exchanger 201 so that the refrigerant circulates through these devices; the voltage conversion circuitry 3 configured to apply to the first motor and the second motor, a converted, which is obtained by converting an AC voltage output from the AC power source 40 based on the voltage command value; and the controller (corresponding to the controller 50) configured to determine the voltage command value based on the parameter of the second motor when the second current value that is the value of the current flowing in the second motor is greater than the first current value that is the value of the current flowing in the first motor, and the current difference value that is the absolute value of the difference between the first current value and the second current value is greater than the predetermined threshold, and to determine the voltage command value based on the parameter of the first motor when the first current value is greater than the second current value and the current difference value is greater than the threshold. With this configuration, the refrigeration cycle apparatus according to Embodiment 2 obtains the same advantages as described regarding Embodiment 1.

In addition, as an additional configuration of the motor driving device 2 according to Embodiment 2, the controller (corresponding to the controller 50) is provided with the main-motor switch 24 configured to switch the motor from which the parameters are obtained. The main-motor switch 24 switches the motor from which the parameters are obtained to the second motor, when it is determined that the voltage command value is determined from parameters in the first motor (corresponding to the first PM motor 6), the second current value is greater than the first current value and also greater than the threshold, and switches the motor from which the parameters are obtained to the first motor, when the voltage command value is determined from the parameters in the second motor, and the first current value is greater than the second current value, and the current difference value is greater than the threshold. The controller changes the parameters to values at which the load on the motor is reduced, when the main-motor switch 24 switches the motor from which the parameters are obtained, and the current flowing in the motor from which the parameters are obtained is greater than the allowable current value, which is determined in advance based on the voltage command value. With this additional configuration, the motor driving device 2 according to Embodiment 2 can perform an operation in consideration of the abnormality, even when the abnormality occurs in the main motor from which the parameters are obtained.

As another additional configuration, the motor driving device 2 according to Embodiment 2 further includes the display 26 configured to indicate that the first motor (corresponding to the first PM motor 6) and the second motor (corresponding to the second PM motor 7) are operated in an operation state different from the normal state, when the parameters are changed to values at which the load to the motors is reduced. With this additional configuration, the motor driving device 2 according to Embodiment 2 can notify the operator of the operation states of the motors.

Furthermore, as an additional configuration, the motor driving method according to Embodiment 2 includes a fifth step of changing the parameters to values at which the load to the motor is reduced, when the main motor is switched in the fourth step and the current flowing in the main motor is greater than the allowable current value, which is determined in advance based on the voltage command value. With this additional configuration, the motor driving device 2 according to Embodiment 2 can perform an operation in consideration of an abnormality even when the abnormality occurs in the main motor.

As another additional configuration, the motor driving method according to Embodiment 2 includes a sixth step of causing the display 26 to indicate that the first motor (corresponding to the first PM motor 6) and the second motor (corresponding to the second PM motor 7) are operated in an operation state different from the normal state, when the parameters are changed to values at which the load to the motor is reduced. With this additional configuration, the motor driving method according to Embodiment 2 can notify the operator of the operation states of the motors.

In addition, as an additional configuration, in the refrigeration cycle apparatus according to Embodiment 2, the controller (corresponding to the controller 50) is provided with the main-motor switch 24 configured to switch the motor from which the parameters are obtained. The main-motor switch 24 switches the motor from which the parameters are obtained to the second motor, when the voltage command value is determined based on the parameters of the first motor (corresponding to the first PM motor 6), the second current value is greater than the first current value, and the current difference value is greater than the threshold, and switches the motor from which the parameters are obtained to the first motor, when the voltage command value is determined based on the parameters of the second motor, the first current value is greater than the second current value, and the current difference value is greater than the threshold. The controller changes the values of the parameters to values at which the load on the motor is reduced, when the main-motor switch 24 switches the motor from which the parameters are obtained and the current flowing in the motor from which the parameters are obtained is greater than the allowable current value, which is determined in advance based on the voltage command value. With this additional configuration, the refrigeration cycle apparatus according to Embodiment 2 can perform an operation in consideration of an abnormality, even when the abnormality occurs in the main motor from which the parameters are obtained.

As another additional configuration, the refrigeration cycle apparatus according to Embodiment 2 further includes the display 26 configured to indicate that the first motor (corresponding to the first PM motor 6) and the second motor (corresponding to the second PM motor 7) are operated in an operation state different from the normal state, when the parameters are changed to values at which the load on the motor is reduced. With this additional configuration, the refrigeration cycle apparatus according to Embodiment 2 can notify the operator of the operation states of the motors.

### Embodiment 3

A motor driving device 60 according to Embodiment 3 will be described. The motor driving device 60 according to Embodiment 3 has a different configuration from those according to Embodiments 1 and 2. The outline of the refrigeration cycle apparatus 100 provided with the motor driving device 2 according to Embodiment 3 and the configuration of the outdoor heat exchanger 104 are the same as those of Embodiments 1 and 2, and their descriptions will thus be omitted.

FIG. 13 is a schematic view illustrating a configuration of the motor driving device 60 according to Embodiment 3. The configuration of the motor driving device 60 will be described with reference to FIG. 13.

The motor driving device 60 is provided with a first temperature detector 61 and a second temperature detector 62. In this regard, the configuration of the motor driving device 60 differs from that of the motor driving device 2. In addition, the motor driving device 60 differs from the motor driving device 2 regarding content to be displayed by a display module 36. Because the configuration of the motor driving device 60 is the same as that of the motor driving device 2 except for the first temperature detector 61 and the second temperature detector 62, its description will be omitted.

The first temperature detector 61 is provided in the vicinity of the first PM motor 6 and is configured to obtain a first temperature value, which is an ambient temperature of the first PM motor 6, at predetermined intervals. The second temperature detector 62 is provided in the vicinity of the second PM motor 7 and is configured to obtain a second temperature value, which is an ambient temperature of the second PM motor 7, at predetermined intervals.

With the first temperature detector 61 and the second temperature detector 62, the motor driving device 60 can determine the type of an abnormality that occurs in each of the motors. More specifically, the motor driving device 60 determines that the main motor is demagnetized when the first temperature value or the second temperature value, which is the ambient temperature of the main motor, is greater than a predetermined allowable temperature value. In addition, the motor driving device 60 determines that the main motor is malfunctioning when the ambient temperature of the main motor is lower than or equal to the predetermined allowable temperature value. The allowable temperature value indicates the upper limitation of the ambient temperature in the case where an abnormality does not occur in the main motor. Moreover, the allowable temperature value is determined as an arbitrary value based on the results of experiment or simulation performed by the designer of the motor driving device 60.

When the ambient temperature of the motor is high, the motor is demagnetized. That is, when an abnormality occurs in the motor under a condition where the ambient temperature of the motor is high, it is possible to presume that the abnormality of the motor is caused by reversible demagnetization of the motor. Furthermore, when an abnormality occurs in the motor under a condition where the ambient temperature of the motor is not high, it is possible to presume that the abnormality of the motor is caused by an irreversible malfunction in the motor.

The display module 36 displays mode information. In addition, the display module 36 displays the type of an abnormality that occurs in the motor, when it is determined that the abnormality occurs in the motor and the motor is operated in the emergency operation mode. That is, the display module 36 indicates that the motor is demagnetized or malfunctioning.

The motor driving device 60 in Embodiment 3 is configured to cause the display module 36 to display the type of abnormality occurring in the motor. With this configuration, the motor driving device 60 can notify the operator of detailed operation states of the motors.

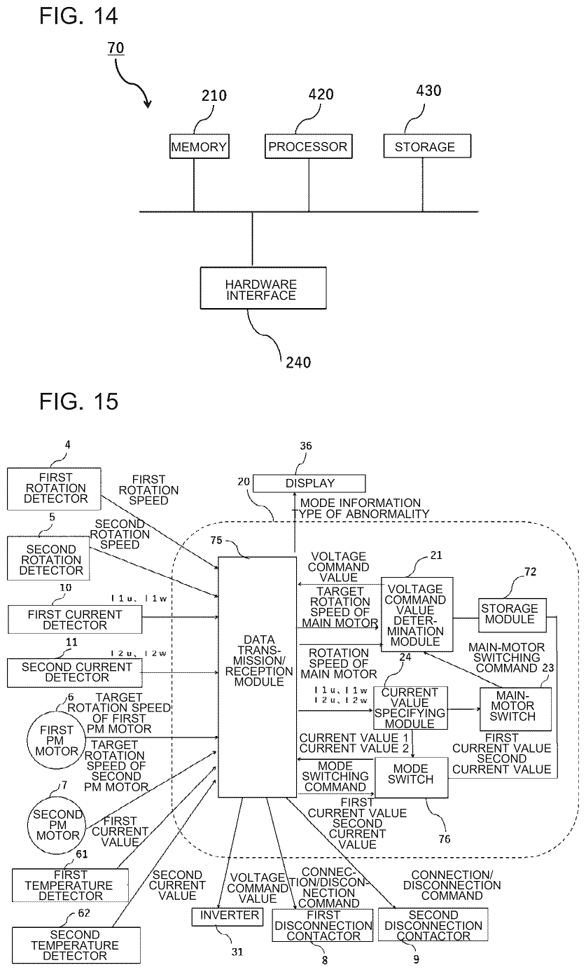

FIG. 14 is a block diagram illustrating a hardware configuration of a controller 70 included in the motor driving device 60 according to Embodiment 3. FIG. 15 is a block diagram illustrating a functional configuration of the controller 70 included in the motor driving device 60 according to Embodiment 3. The controller 70 will be described with reference to FIGS. 14 and 15.

The hardware configuration of the controller 70 differs from that of Embodiment 2 regarding the program that is run by a processor 420 and information that is stored in a storage 430. Except for the program that is run by the processor 420 and the information that is stored in the storage 430, the configuration of the controller 70 is the same as that of the controller 50 and its description will thus be omitted.

The processor 420 is configured to run a program to determine a voltage command value, a program to specify a first current value that is the value of the current flowing in the first PM motor 6 and a second current value that is the value of the current flowing in the second PM motor 7, a program to determine whether or not to switch the main motor, a program to determine whether or not to switch the operation mode of the first PM motor 6 and that of the second PM motor 7, and a program to determine the type of abnormality occurring in the main motor when the first PM motor 6 and the second PM motor 7 are operated in the emergency operation mode.

The storage 430 is configured to store a threshold for a current difference value, an allowable current value, and a main-motor switching count, and an allowable temperature value.

The functional configuration of the controller 70 differs from that of Embodiment 2 regarding content that is stored in a storage module 72, signals that are transmitted and received by a data transmission/reception module 75, and processing by a mode switch 76. Except for the content that is stored in the storage module 72, the signals that are transmitted and received by the data transmission/reception module 75, and the processing by the mode switch 76, the configuration of the controller 70 is the same as that of the controller 50 and their description will thus be omitted.

The storage module 72 stores a threshold for the current difference value, an allowable current value, a main-motor switching count, and an allowable temperature value.

Unlike Embodiment 2, the data transmission/reception module 75 receives a first temperature value from the first temperature detector 61 and a second temperature value from the second temperature detector 62. In addition, the data transmission/reception module 75 transmits a signal including mode information and a signal including the type of abnormality of the motor to the display module 36. On those points, the data transmission/reception module 75 is different from that of Embodiment 2.

The mode switch 76 determines whether or not to switch the operation mode of the first PM motor 6 and that of the second PM motor 7 and determines the type of an abnormality that occurs in the motor. The type of the abnormality that is determined by the mode switch 76 is displayed by the display module 36.

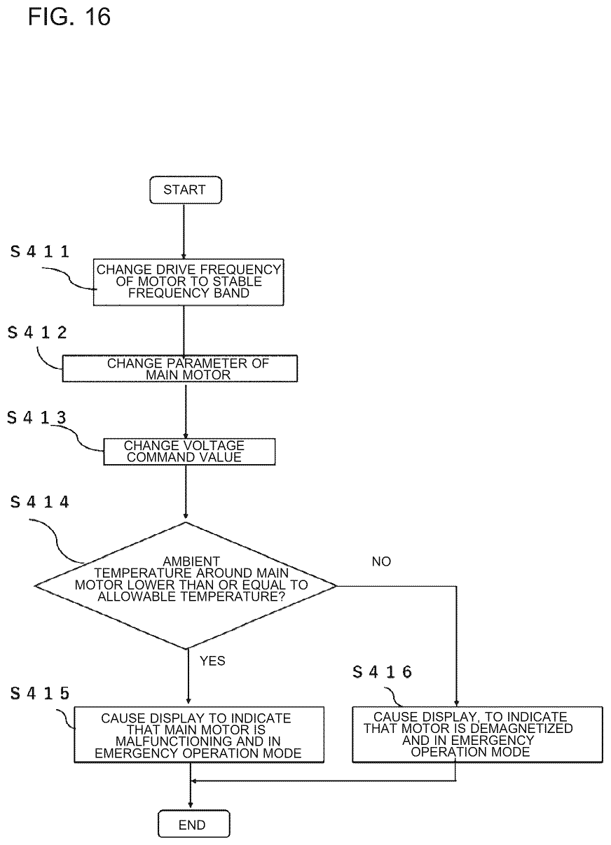

FIG. 16 is a flowchart illustrating processing in the emergency operation mode in the mode switching determination processing by the controller 70 included in the motor driving device 60 according to Embodiment 3. The processing by the controller 70 will be described with reference to FIG. 16. The main-motor switching determination processing and the mode switching determination processing by the controller 70 in the motor driving device 60 according to Embodiment 3 are the same as those of the controller 50 and their descriptions will thus be omitted.

The process of step S411 is executed when it is determined in step S302 that an abnormality occurs in the main motor (Yes in step S302). The processes of steps S411 to S413 are the same as that of steps S311 to S313 according to Embodiment 2 and their descriptions will thus be omitted. The process of step S413 is ended when the voltage command value determination module 21 determines the voltage command value.

The process of step S414 is executed after the process of step S413. In step S414, the mode switch 76 of the controller 70 determines whether or not the ambient temperature of the main motor is lower than or equal to the allowable temperature value stored in the storage module 72. In step S414, the mode switch 76 obtains the first temperature when the main motor is the first PM motor 6 and obtains the second temperature when the main motor is the second PM motor 7. The process of step S414 is ended when the mode switch 76 determines whether or not the condition is satisfied.

The process of step S415 is executed when it is determined in step S414 that the ambient temperature of the main motor is lower than or equal to the allowable temperature value (Yes in step S414). In step S415, the data transmission/reception module 75 of the controller 70 transmits, to the display module 36, a signal including a signal indicating that the first PM motor 6 and the second PM motor 7 are operated in the emergency operation mode and an abnormality occurs in the main motor. The process of step S415 is ended when the data transmission/reception module 75 transmits the signal to the display module 36.

The process of step S416 is executed when it is determined in step S414 that the first temperature or the second temperature is higher than the allowable temperature (No in step S414). In step S416, the data transmission/reception module 75 of the controller 70 transmits, to the display module 36, a signal indicating that the first PM motor 6 and the second PM motor 7 are operated in the emergency operation mode and the main motor is demagnetized by the high temperature. The process of step S416 is ended when the data transmission/reception module 75 transmits the signal to the display module 36.

When step S415 or S416 is ended, the process of step S303 is ended.

As described above, the motor driving device 60 according to Embodiment 3 includes the voltage conversion circuitry 3 configured to apply to the first motor (corresponding to the first PM motor 6) and the second motor (corresponding to the second PM motor 7), a converted AC voltage obtained by converting an AC voltage output from the AC power source 40 based on the voltage command value, and a controller (corresponding to the controller 70) configured to determine the voltage command value based on the parameter of the first motor when the first current value that is the value of the current flowing in the first motor is greater than the second current value that is the value of the current flowing in the second motor, and the current difference value that is the absolute value of the difference between the first current value and the second current value is greater than the predetermined threshold, and to determine the voltage command value based on the parameter of the second motor when the second current value is greater than the first current value and the current difference value is greater than the threshold. With this configuration, the motor driving device 60 according to Embodiment 3 can the same advantages as described regarding Embodiment 1.

In addition, the motor driving method according to Embodiment 3 includes: a first step of obtaining a first current value that is applied to the first motor (corresponding to the first PM motor 6) and a second current value that is applied to the second motor (corresponding to the second PM motor 7); a second step of calculating a current difference value that is the absolute value of the difference between the first current value and the second current value both obtained in the first step; a third step of using the second motor as the main motor when the second current value is greater than the first current value and the current difference value is greater than the predetermined threshold, and of using the first motor as the main motor when the first current value is greater than the second current value and the current difference value is greater than the threshold; and a fourth step of applying to the first motor and the second motor, a converted AC voltage that is obtained by converting an AC voltage output from the AC power source 40 based on the voltage command value determined based on the parameter of the main motor that is determined in the third step. With this configuration, the motor driving method according to Embodiment 3 can the same advantages as described regarding Embodiment 1.

Furthermore, the refrigeration cycle apparatus according to Embodiment 3 includes: the compressor 102; the outdoor heat exchanger 104 including the first outdoor heat exchanger 121 that is provided with the first motor (corresponding to the first PM motor 6) and the second outdoor heat exchanger 122 that is provided with the second motor (corresponding to the second PM motor 7) and connected in the refrigerant circuit in parallel with the first outdoor heat exchanger 121; the pressure reducing device 103; the indoor heat exchanger 201; refrigerant pipes (corresponding to the pipes 301) that connect the compressor 102, the outdoor heat exchanger 104, the pressure reducing device 103, and the indoor heat exchanger 201 so that the refrigerant circulates through these devices; the voltage conversion circuitry 3 configured to apply a converted AC voltage, which is obtained by converting an AC voltage output from the AC power source 40 based on the voltage command value, to the first motor and the second motor; and the controller (corresponding to the controller 70) configured to determine the voltage command value based on the parameter of the second motor, when the second current value that is the value of the current flowing in the second motor is greater than the first current value that is the value of the current flowing in the first motor, and the current difference value that is the absolute value of the difference between the first current value and the second current value is greater than the predetermined threshold, and to determine the voltage command value based on the parameter of the first motor, when the first current value is greater than the second current value and the current difference value is greater than the threshold. With this configuration, the refrigeration cycle apparatus according to Embodiment 2 can obtain the same advantages as described regarding Embodiment 1.

In addition, as an additional configuration, the motor driving device 60 according to Embodiment 3 further includes temperature detectors (corresponding to the first temperature detector 61 and the second temperature detector 62) configured to detect respective ambient temperatures of the first motor (corresponding to the first PM motor 6) and the second motor (corresponding to the second PM motor 7). The controller (corresponding to the controller 70) determines that the motor from which parameters are obtained is demagnetized when the parameters are changed to values at which the load on the motor is reduced and the temperature detected by the temperature detector is higher than the predetermined allowable temperature value, and determines that the motor from which the parameters are obtained is malfunctioning when the parameters are changed to values at which the load on the motor is reduced and the temperature detected by the temperature detector is lower than or equal to the predetermined allowable temperature value. With this additional configuration, the motor driving device 60 according to Embodiment 3 can determine the type of an abnormality that occurs in the main motor, which is the motor from which the parameters are obtained.

Furthermore, as an additional configuration of the motor driving device 60 according to Embodiment 3, the display module 36 is configured to display demagnetization of the motor, when it is determined that the motor from which the parameters are obtained are demagnetized, and to display the malfunction of the motor when it is determined that the motor from which the parameters are obtained is malfunctioning. With this additional configuration, the motor driving device 60 according to Embodiment 3 can notify the operator of detailed operating states of the motors.

Furthermore, as an additional configuration, the motor driving method according to Embodiment 3 includes a seventh step of determining that the main motor is demagnetized, when the parameters are changed to values at which the load on the motor is reduced and the ambient temperature of the first motor (corresponding to the first PM motor 6) or the second motor (corresponding to the second PM motor 7) is higher than the predetermined allowable temperature value, and an eight step of determining that the main motor is malfunctioning, when the parameters are changed to values at which the load on the motor is reduced and the ambient temperatures of the first motor and the second motor are lower than or equal to the predetermined allowable temperature value. With this additional feature, the motor driving method according to Embodiment 3 can determine the type of the abnormality in the main motor.

Moreover, as another additional configuration, the motor driving method according to Embodiment 3 includes a ninth step of causing the display module to display demagnetization of the main motor, when it is determined in the seventh step that the main motor is demagnetized, and of causing the display module to display the abnormality of the main motor, when it is determined in the eighth step that the main motor is malfunctioning. With this additional configuration, the motor driving method according to Embodiment 3 can notify the operator of detailed operating states of the motors.

In addition, as an additional configuration, the refrigeration cycle apparatus according to Embodiment 3 further includes temperature detectors (corresponding to the first temperature detector 61 and the second temperature detector 62) configured to detect respective ambient temperatures of the first motor (corresponding to the first PM motor 6) and the second motor (corresponding to the second PM motor 7). The controller (corresponding to the controller 70) determines that the motor from which the parameters are obtained are demagnetized when the parameters are changed to values at which the load on the motor is reduced and the temperature detected by the temperature detector is higher than the predetermined allowable temperature value, and determines that the motor from which the parameters are obtained is malfunctioning when the parameters are changed to values at which the load on the motor is reduced and the temperature detected by the temperature detector is lower than or equal to the predetermined allowable temperature value. With this additional configuration, the refrigeration cycle apparatus according to Embodiment 3 can determine the type of the abnormality in the main motor, which is the motor from which the parameters are obtained.

As another additional configuration of the refrigeration cycle apparatus according to Embodiment 3, the display module 36 is configured to display demagnetization of the motor from which the parameters are obtained, when it is determined that the motor from which the parameters are obtained is demagnetized, and display the malfunction of the motor, when it is determined that the motor from which the parameters are obtained is malfunctioning. With this additional configuration, the refrigeration cycle apparatus according to Embodiment 3 can notify the operator of detailed operating states of the motors.

It should be noted that in Embodiment 3, the first temperature detector is provided in the vicinity of the first PM motor and the second temperature detector is provided in the vicinity of the second PM motor, but this is not limiting. It suffices that a temperature detector is provided in the vicinity of a motor. The number of temperature detectors may be one or may be three or more, In addition, in Embodiment 3, the display module is configured to change the display based on the type of an abnormality in the motor, but this is not limiting. The control of the motor may be changed based on the type of abnormality in the motor. For example, the motor driving device may be configured to stop the operation of the main motor, when it is determined that the motor is malfunctioning.

Furthermore, in Embodiment 3, the types of abnormalities are malfunctioning and demagnetization, that is, two types of abnormalities are present, but this is not limiting. For example, it may be determined from heat generated by the motor itself whether or not an abnormality occurs. In such a case, it is determined that heat is abnormally generated in the motor when the first temperature detector or the second temperature detector periodically obtains an ambient temperature before driving and an ambient temperature during driving and the difference between the temperatures reaches a certain level or more.

Although preferred embodiments are described in detail as above, the present disclosure is not limited to the above embodiments. Various modifications and substitutions of the above embodiments can be made without departing from the scope of the CLAIMS.

### REFERENCE SIGNS LIST

1: motor driving device, 2: motor driving device, 3: voltage conversion circuitry, 4: first rotation detector, 5: second rotation detector, 6: first PM motor, 7: second PM motor, 8: first disconnection contactor, 9: second disconnection contactor, 10: first current detector, 11: second current detector, 12: first U-phase power line, 13: first V-phase power line, 14: first W-phase power line, 15: second U-phase power line, 16: second V-phase power line, 17: second W-phase power line, 20: controller, 22: storage module, 21: voltage command value determination module, 22: storage module, 23: current value specifying module, 24: main-motor switch, 25: data transmission/reception module, 26: display, 30: converter, 31: inverter, 32: storage module, 34: mode switch, 35: data transmission/reception module, 36: display module, 40: AC power source, 41: inverter, 50: controller, 60: motor driving device, 61: first temperature detector, 62: second temperature detector, 70: controller, 72: storage module, 75: data transmission/reception module, 76: mode switch, 100: refrigeration cycle apparatus, 101: four-way valve, 102: compressor, 103: pressure reducing device, 104: outdoor heat exchanger, 110: indoor unit, 120: outdoor unit, 121: first outdoor heat exchanger, 122: second outdoor heat exchanger, 123: first fan, 124: second fan, 201: indoor heat exchanger, 210: memory, 220: processor, 230: storage, 240: hardware interface, 301: pipe, 320: processor, 330: storage, 420: processor, 430: storage

1. A motor driving device comprising:
voltage conversion circuitry configured to apply to a first motor and a second motor, a converted AC voltage obtained by converting an AC voltage output from an AC power source based on a voltage command value;
a controller configured to determine the voltage command value based on a parameter of the first motor, when a first current value that is a value of a current flowing in the first motor is greater than a second current value that is a value of a current flowing in the second motor and a current difference value that is an absolute value of a difference between the first current value and the second current value is greater than a predetermined threshold, and to determine the voltage command value based on a parameter of the second motor, when the second current value is greater than the first current value and the current difference value is greater than the threshold.

2. The motor driving device of claim 1, wherein
the first current value is an instantaneous value of the current flowing in the first motor, and
the second current value is an instantaneous value of the current flowing in the second motor.

3. The motor driving device of claim 1, wherein
the first current value is a value of a torque current component of the current flowing the first motor, and
the second current value is a value of a torque current component of the current flowing in the second motor.

4. The motor driving device of claim 1, wherein the parameters include a rotation speed.

5. The motor driving device of claim 1, wherein
the first motor and the second motor are three-phase AC motors, and
the voltage conversion circuitry includes a converter configured to convert an AC voltage output from the AC power source into a DC voltage, and an inverter configured to apply to the first motor and the second motor, a three-phase AC voltage into which the DC voltage obtained by conversion performed by the converter is converted based on the voltage command value.

6. The motor driving device of claim 5, wherein
the first current value is determined by detection of current values of two or more phases of the first motor, and
the second current value is determined by detection of current values of two or more phases of the second motor.

7. The motor driving device of claim 1, wherein the controller is configured to determine the voltage command value by performing a vector control based on the parameter of the first motor or the second motor.

8. The motor driving device of claim 1, wherein
the controller includes a main-motor switch configured to switch the motor from which the parameter is obtained,
the main-motor switch is configured to switch the motor from which the parameter is obtained to the second motor, when the voltage command value is determined based on the parameter of the first motor, the second current value is greater than the first current value, and the current difference value is greater than the threshold, and to switch the motor from which the parameter is obtained to the first motor, when the voltage command value is determined based on the parameter of the second motor, the first current value is greater than the second current value, and the current difference value is greater than the threshold, and
the controller is configured to change the parameter to a value at which a load on the motor is reduced, when the main-motor switch switches the motor from which the parameter is obtained and a current flowing in the motor from which the parameter is obtained is greater than an allowable current value determined in advance based on the voltage command value.

9. The motor driving device of claim 8, further comprising:
a display configured to indicate that the first motor and the second motor are operated in an operation state different from a normal state, when the parameter is changed to the value at which the load on the motor is reduced.

10. The motor driving device of claim 8, further comprising:
a temperature detector configured to detect an ambient temperature of the first motor and the second motor,
wherein the controller is configured to determine that the motor from which the parameter is obtained is demagnetized, when the parameter is changed to the value at which the load on the motor is reduced and a temperature detected by the temperature detector is higher than a predetermined allowable temperature value, and determine that the motor from which the parameter is obtained is malfunctioning, when the parameter is changed to the value at which the load on the motor is reduced and the temperature detected by the temperature detector is lower than or equal to the predetermined allowable temperature value.

11. The motor driving device of claim 10, further comprising:
a display configured to indicate demagnetization of the motor from which the parameter is obtained, when it is determined that the motor from which the parameter is obtained is demagnetized, and indicate a malfunction of the motor from which the parameter is obtained, when it is determined that the motor from which the parameter is obtained is malfunctioning.

12. A motor driving method comprising:
obtaining a first current value that is applied to a first motor and a second current value that is applied to a second motor;
calculating a current difference value that is an absolute value of a difference between the first current value and the second current value that are obtained
using the second motor as a main motor when the second current value is greater than the first current value and the current difference value is greater than a predetermined threshold, and using the first motor as the main motor when the first current value is greater than the second current value and the current difference value is greater than the threshold; and
applying to the first motor and the second motor, a converted AC voltage obtained by converting an AC voltage output from an AC power source based on a voltage command value determined based on a parameter of the main motor

13. A refrigeration cycle apparatus comprising:
a compressor;
an outdoor heat exchanger including a first outdoor heat exchanger that is provided with a first motor and a second outdoor heat exchanger that is provided with a second motor and connected in a refrigerant circuit in parallel with the first outdoor heat exchanger;
a pressure reducing device;
an indoor heat exchanger;
refrigerant pipes that connect the compressor, the outdoor heat exchanger, the pressure reducing device, and the indoor heat exchanger so that refrigerant circulates through the compressor, the outdoor heat exchanger, the pressure reducing device, and the indoor heat exchanger; and
a motor driving device including voltage conversion circuitry configured to apply to the first motor and the second motor, a converted AC voltage obtained by converting an AC voltage output from an AC power source based on a voltage command value, and a controller configured to determine the voltage command value based on a parameter of the second motor, when a second current value of a current flowing in the second motor is greater than a first current value of a current flowing in the first motor and a current difference value that is an absolute value of a difference between the first current value and the second current value is greater than a predetermined threshold, and to determine the voltage command value based on a parameter of the first motor, when the first current value is greater than the second current value and the current difference value is greater than the threshold.
